(19) United States
(12) Patent Application Publication
(10) Pub. No.: US 2005/0265580 A1
(43) Pub. Date: Dec. 1, 2005

(54) System and method for a motion visualizer

(76) Inventors: Paul Antonucci, Watertown, MA (US); Nathan Kimball, Newton, MA (US); Ricardo Nemirovsky, Arlington, MA (US)

Correspondence Address: AKC PATENTS, 215 GROVE ST., NEWTON, MA, 02466, US

(21) Appl. No.: 11/135,577

(22) Filed: May 23, 2005

Related U.S. Application Data
(60) Provisional application No. 60/575,031, filed on May 27, 2004.

(51) Int. Cl. G06K 9/00

(52) U.S. Cl. 382/103

(57) ABSTRACT

A system for capturing and displaying the motion of an object includes a first equipment for capturing a first set of visual images of the object's motion over time and a computing device for receiving a signal of the first set of visual images of the object's motion and converting the signal of the first set of visual images into a graphical representation of the object's motion. The system displays the graphical representation of the object's motion on a display screen in real time with the capturing of the first set of visual images. The system may also include a second equipment for capturing a second set of visual images of the object's motion over time and the computing device then combines the first and second set of visual images to provide a real-time three-dimensional graphical representation of the object's motion.

### CROSS REFERENCE TO RELATED CO-PENDING APPLICATIONS

This application claims the benefit of U.S. provisional application Ser. No. 60/575,031 filed on May 27, 2004 and entitled MOTION VISUALIZER which is commonly assigned and the contents of which are expressly incorporated herein by reference.

### FIELD OF THE INVENTION

The present invention relates to a system and a method for a motion visualizer, and more particularly to a motion visualizer that combines object-locating technology utilizing video sensors and real-time data presentation.

### BACKGROUND OF THE INVENTION

Probes and computers have been used in education for measuring a variety of quantities such as temperature, light intensity, pH, sound, as well as motion. Since the 1980's, systems used for real-time motion detection in education have utilized the method of ultrasonic ranging that detects distance by bouncing sound waves off the object of interest and timing the return echo. A number of these systems are commercially available. These systems have, in general, been one-dimensional and work in the range of about 0.5 m up to 6 or 7 m under ideal circumstances. Occasionally, people have tried to use two or three ultrasonic rangers simultaneously at right angles to measure motion in two or three dimensions. However, this works poorly because of interference between detectors and the lack of simultaneity between them. Only one ultrasonic system that overcame these problems has been designed for 2- or 3-dimensional motion. This is the V-Scope designed by the Litek company (Israel) and marketed to education and other markets. It was introduced around 1990 and was quite expensive. The V-scope had limitations of range, and the problem that the object to be detected had to have a “button” that produced an ultrasonic “beep” attached to it. Furthermore, the software that was used with the system did not represent a 3D view of the data. The few V-Scopes that were sold were used largely for research. This system is no longer available.

The first use of educational video motion detection started around 1992 with the idea that a saved video tape of a motion could be digitized and examined frame-by-frame. The pixel location of the moving point of interest could be mouse-clicked in each frame thereby creating motion data when the (x, y) mouse data was appropriately calibrated and scaled. Before software was developed to do this, video motions studies were accomplished using VCRs that could advance videotape frame-by-frame where the object of interest was tracked using a pen on an acetate sheet over the TV screen. This approach has been used in several commercial products the most successful of which is Videopoint by Lenox Softworks. An advantage of this approach is that motions of real life (not just laboratory motions) may be analyzed and students may record and analyze motions of their own interest. Video may be stored on disk and analyzed later with students examining the points on each video that they choose. The product disk of Videopoint comes with many video clips from various interesting sources such as NASA space shots, amusements park rides, and sports activities. However, the data extraction process is tedious and error-prone. The labor intensive process of frame-by-frame clicking practically limits the duration of motions that students analyze to several dozen frames (a second or two or less at a frame rate of 30 Hz). Furthermore the accuracy is dependant on the accuracy of mouse clicking and is never better than one pixel. Also, from an educational point-of-view the delay between making the motion and seeing a graph is not desirable. Accordingly, there is a need for a motion detection system that records and displays three-dimensional motion of objects in real time.

### SUMMARY OF THE INVENTION

In general, in one aspect, the invention features a system for capturing and displaying the motion of an object. The system includes a first equipment for capturing a first set of visual images of the object's motion over time and a computing device for receiving a signal of the first set of visual images of the object's motion and converting the signal of the first set of visual images into a graphical representation of the object's motion. The system displays the graphical representation of the object's motion on a display screen in real time with the capturing of the first set of visual images.

Implementations of this aspect of the invention may include one or more of the following features. The graphical representation of the object's motion comprises a position coordinate graph, or a position versus time graph. The system may further include a second equipment for capturing a second set of visual images of the object's motion over the time. In this case, the computing device receives a signal of the second set of visual images and combines the second set visual image signal with the first set visual image signal and converts the combined first set and second set visual image signals into a graphical representation of the object's motion and displays the graphical representation on the display screen in real time with the capturing of the first set and second set of visual images. In this case the graphical representation comprises a three-dimensional position coordinate graph. The computing device converts the combined first set and second set of visual image signals into a graphical representation of the object's motion via triangulation. The first and the second equipment comprise a first and a second optical axis, respectively, and are arranged so that their corresponding first and second optical axes are at a known angle and the first and the second equipment are equidistant from the first and the second optical axes' intersection point. The three-dimensional position coordinate graph comprises the object's position coordinates plotted in a three-dimensional x-y-z Cartesian coordinate system. The x-y-z Cartesian coordinate system comprises an origin located at the intersection point of the first and the second optical axes, an x-axis running parallel to a line joining the first and the second equipment, a y-axis running perpendicular to the line joining the first and the second equipment directly between the first and the second capturing equipment and a z-axis running vertical through the origin. The length of the line joining the first and the second equipment is used to scale and calculate the position coordinates in true distance units. The system may further include a video controller for receiving an analog signal of the first set of visual images, locating the object and transmitting a signal of the object's location to the computing device. The object includes a bright color and the video controller locates the object in the first set of visual images based on the bright color exceeding a set threshold level of brightness. The signal of the object's location includes average x-pixel position, average y-pixel position, object average height, and object average width. The signal may be a digital video signal and the computing device may further include an object locating algorithm for receiving the digital video signal and locating the object. Again, the object may have a bright color and the object locating algorithm may locate the object's position coordinate data in the first set of visual images based on the bright color exceeding a set threshold level of brightness. The first set of visual images comprise motions of more than one objects. The first set of visual images may be captured at a frequency of 30 times per second. The first set and the second set of visual images are captured at a frequency of 30 times per second each and the computing device receives interlaced images of the first set and the second set of visual images at a frequency of 60 times per second. The first capturing equipment may be a video camera, a video recorder, a NTSC camcorder or a PAL camcorder. The graphical representation of the object's motion may be a velocity versus time graph or an acceleration versus time graph. The object's position coordinate data are smoothed to correct for small and random errors via an algorithm that fits a parabola to an odd number of adjacent position coordinate data using a least-squares method. The object's position coordinate data are filtered using filters selected from a group consisting of a minimum object size filter, a debounce horizontal filter, a debounce vertical filter, and an object overlap filter. The computing device may be a personal computer, a notebook computer, a server, a computing circuit, or a personal digital assistant (PDA).

In general, in another aspect, the invention features a method for capturing and displaying motion of an object. The method includes providing a first equipment for capturing a first set of visual images of the object's motion over time and then providing a computing device for receiving a signal of the first set of visual images of the object's motion and converting the signal of the first set of visual images into a graphical representation of the object's motion and displaying the graphical representation of the object's motion on a display screen in real time with the capturing of the first set of visual images.

In general, in another aspect, the invention features a method of using real-time video analysis of an object's motion for teaching kinematic processes in physics and mathematics courses. The method includes providing a system for capturing and displaying motion of an object where the system comprises a first equipment for capturing a first set of visual images of the object's motion over time and a computing device for receiving a signal of the first set of visual images of the object's motion and converting the signal of the first set of visual images into a graphical representation of the object's motion and displaying the graphical representation of the object's motion on a display screen in real time with the capturing of the first set of visual images. Next, asking a student to imagine and draw a three dimensional representation of a first object's motion, then performing the first object's motion and capturing the first object's motion with the system for capturing and displaying motion of an object and finally comparing the student's drawing of the three-dimensional representation of the first object's motion with the display of the first object's motion by the system.

Among the advantages of this invention may be one or more of the following. The system provides a real time representation and display of position coordinate data of a moving object. The system also provides velocity and acceleration data of the moving object in real time. The system provides three-dimensional and/or two dimensional representation and display of position coordinate data of a moving object. It may track more than one moving object. It is inexpensive and can be used for educational purposes in teaching physics and mathematics of kinematics. It utilizes equipments that are readily available in most schools, such as video cameras and computers.

### BRIEF DESCRIPTION OF THE DRAWINGS

Referring to the figures, wherein like numerals represent like parts throughout the several views:

FIG. 1 is a schematic diagram of a 3-dimensional motion visualizer system;

FIG. 2 depicts the set video levels screen of the motion visualizer program;

FIG. 3 is a schematic diagram of a video frame depicting the object image and the x-position location method;

FIG. 4 is a block diagram of the hardware architecture of the motion visualizer system of FIG. 1;

FIG. 5 is a block diagram of the process for setting up and operating the motion visualizer system of FIG. 1;

FIG. 6 is a schematic diagram of the alignment tool for the motion visualizer system of FIG. 1;

FIG. 7 is a schematic diagram of a 2-dimensional motion visualizer system recording motion of an object in a vertical plane;

FIG. 8 is a schematic diagram of a 2-dimensional motion visualizer system recording motion of an object in a horizontal plane;

FIG. 9 is a schematic diagram of a video frame depicting two object images and the x- and y-position location method;

FIG. 10 is a picture of a 3-dimensional motion visualizer system recording the motion of a pendulum;

FIG. 11 depicts the three dimensional x-y-z coordinate graph, the x-coordinate versus time and y-coordinate versus time graph of the pendulum of FIG. 10;

FIG. 12 is a picture of a 2-dimensional motion visualizer system recording the 2-dimesional motion of two objects;

FIG. 13 depicts the two dimensional x-y coordinate graph, the x-velocity versus time and y-velocity versus time graph of the two objects of FIG. 12;

FIG. 14 is a picture of a motion visualizer system recording the juggling motion of three objects; and

FIG. 15 depicts the three-dimensional x-y-z coordinate graph of the juggling motion of one of the objects of FIG. 14.

### DETAILED DESCRIPTION OF THE INVENTION

The motion visualizer is a hardware and software system used to record and study the motion of objects. It utilizes live video input to track and record the motion of an object based on its color and it displays and analyzes the recorded motion in real time.

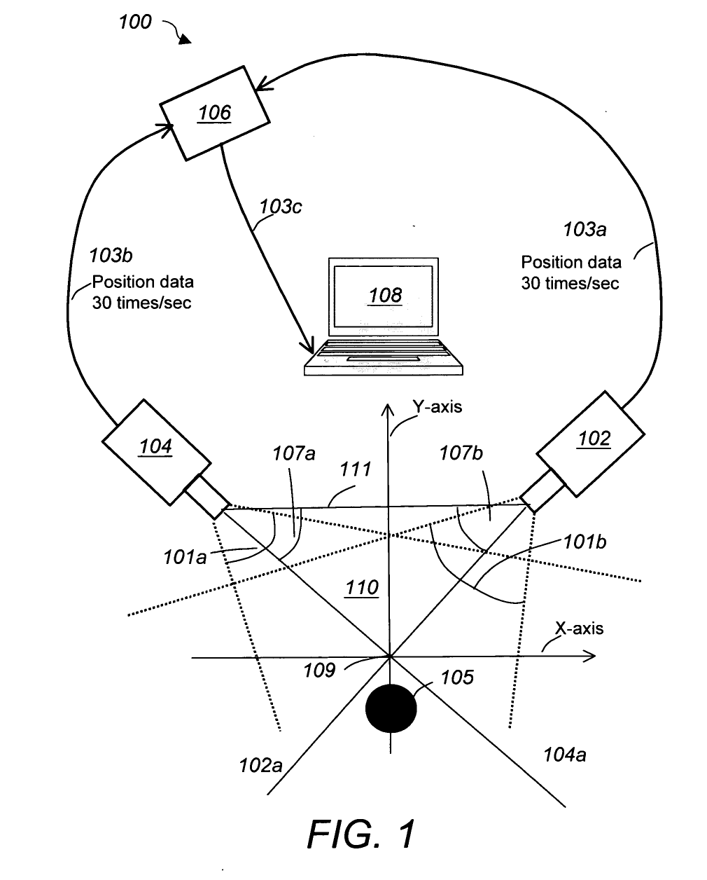

Referring to FIG. 1, a three dimensional (3D) motion visualizer system 100 includes two video cameras 102, 104, a video controller 106 and a computer 108. The two video cameras are placed at a distance from each other so as to cover the optical field 110 where the moving object 105 is located. The video signals from the two video cameras 102, 104 comprise the object's 105 position data and are fed into the video controller 106 via cables 103a and 103b, respectively, at a rate of 60 times per second. The position data are displayed and analyzed by the computer 108. In other embodiments the object's position data are transmitted wirelessly to the video controller 106 and computer 108. Video cameras 102, 104 are standard color National Television Standards Committee (NTSC) camcorders or video cameras. The computer 108 is a personal computer, a notebook computer, a server or any other computing circuit. The video controller 106 plugs into the computer 108 via a serial port. The object 105 is brightly colored with a specific color and the specific color is used to identify and track the object. Examples of bright colors include orange, fluorescent green or yellow. If the object 105 is not directly colored a brightly colored marker or tag is added onto it. The chosen specific color has to be unique in the video camera's field of view in order to be able to provide unique identification of the moving object 105. However, this is not always possible and in those cases the system uses additional criteria to identify the moving object from other objects that may have similar color. The most important secondary criterion for identifying the moving object is brightness of the specific color. In general, the object-of-interest is discriminated from other objects of the same color if it is the brightest instance of that color in the camera's view. In order to be able to discriminate between two object of the same color, but with different brightness level the user needs to calibrate the motion visualizer, by setting a video level or threshold level. The computer 108 then uses an object-locating algorithm to identify objects in the camera's field-of-view that exceed this threshold level. The threshold level is set such that it is higher than the second brightest instance of the specific color and lower than the brightest instance of the specific color, which represents the moving object. Accordingly, in order to set the video threshold, the user needs to take the following points into consideration:
a. Be sure the moving object is the brightest instance of the specific color
b. Know the threshold of the second brightest instance of the specific color so that the threshold can be set (usually mid-way) between the brightest object and the next-to-brightest object.

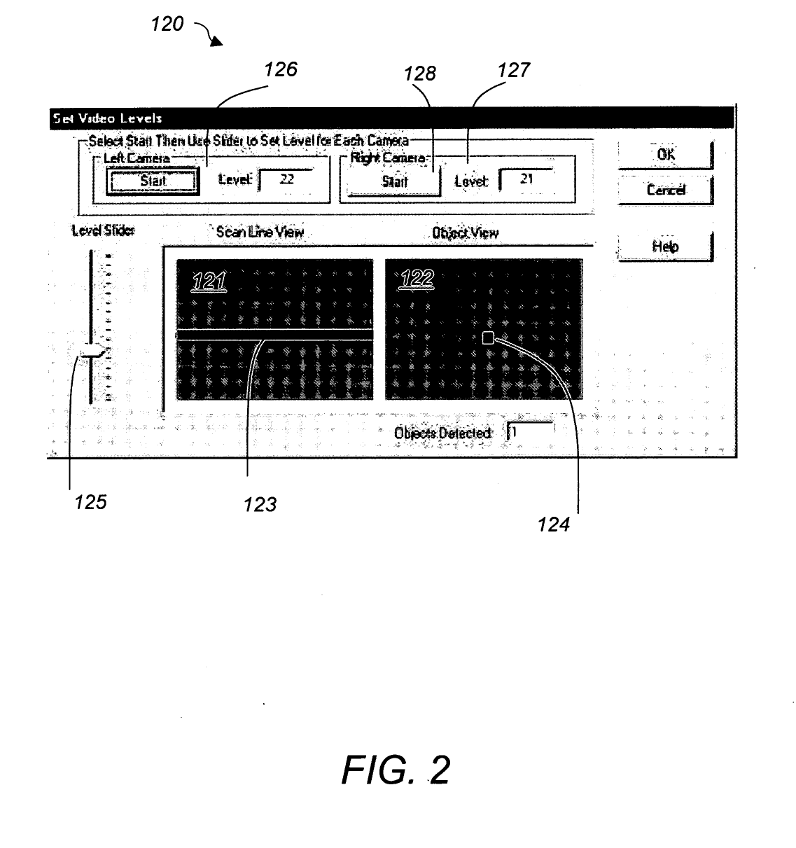

If the moving object is not the brightest object in the camera's view or if the second brightest object is very close in brightness to the moving object's brightness then the user must make adjustments either to the moving object or the field-of-view. This can be accomplished in several ways. For example, the moving object may be made brighter or more directly illuminated, or the extra instances of the specific color are removed from the camera view. However, in order to arrange for good object tracking, the user needs good feedback from the system. The motion visualizer system includes a real-time feedback mechanism for detecting the moving object, shown in FIG. 2. Referring to FIG. 2, a Set Video Levels screen 120 depicts a user-friendly way of seeing the detected objects similar to the way the search algorithm does. The Set Video Levels screen 120 has two windows 121, 122 that both represent the video camera's view. One window 121 is called the Scan Line View and the other 122 is the Object View. The Scan Line View 121 shows a colored horizontal line 123 indicating the height in the video frame of each scan line where an object exceeds the presently set threshold level. It is a very sensitive indicator of the height of potential detected objects. The Object View 122 shows how the search algorithm turns these potential targets into found objects 124. Because of various filtering mechanisms, some instances of the specific color that exceed the threshold level are not recorded as found objects. A slider 125 on the side of the screen sets allows setting the threshold level by moving the computer mouse. Two buttons at the top of the screen 126, 127, select which camera (i.e., left 102 or right 104) is to be activated for threshold level setting. As the screen responds in real-time, the user identifies the object of interest by seeing it move on the screen when it is physically moved. The user can also find the relative position of other distracting objects so that he can remove them or cover them. This real time feedback mechanism is also good for detecting anomalies of the moving object, such as a highly specular (i.e., smooth and reflective) surface that has a large reflection on it that causes the detected object to “break up.”

In addition to the real-time visual feedback mechanism, the system also offers an “automatic level setting” feature that finds the levels of the brightest object and the second brightest object and sets the threshold mid-way between them. The problem with the “automatic level setting” is that without the visual check of the data, it is extremely difficult to “debug” a setup if there is a problem. The system also includes a manual override for threshold level setting in very unusual situations.

If more than one instance of the specific color and brightness in the camera's view exceeds the set threshold level then multiple moving objects can be detected. The list below demonstrates how tracking multiple objects may be used to expand the possibilities of the system:
a. Multiple objects of the same color may be tracked using a video object-tracking technique known as optical flow, where frame-to-frame comparisons of position are made to keep individual objects identified separately.
b. “False” objects that can not be removed from a video camera's view may be identified and deleted from the data stream. For instance, if the object is red, but a red “Exit” sign is in the view of the camera then data from that location of the camera's view could be rejected.
c. If multiple objects are captured then they may be compared for additional filtering. For instance, the algorithm does also capture an averaged “size” (i.e., width and height) of each object, so that either large or small objects could be tracked or filtered. Another example is that objects found in parts of the camera's view could be selected. For instance, the higher object may be the one of interest and the lower one is rejected.

The above-mentioned filters are implemented by the micro-controller in the video controller 106 and are settable from the main program. In general, the limits to implementing additional processing of this nature are constrained by the speed and memory of the micro-controller. However, using faster and larger chips, these constraints can be overcome.

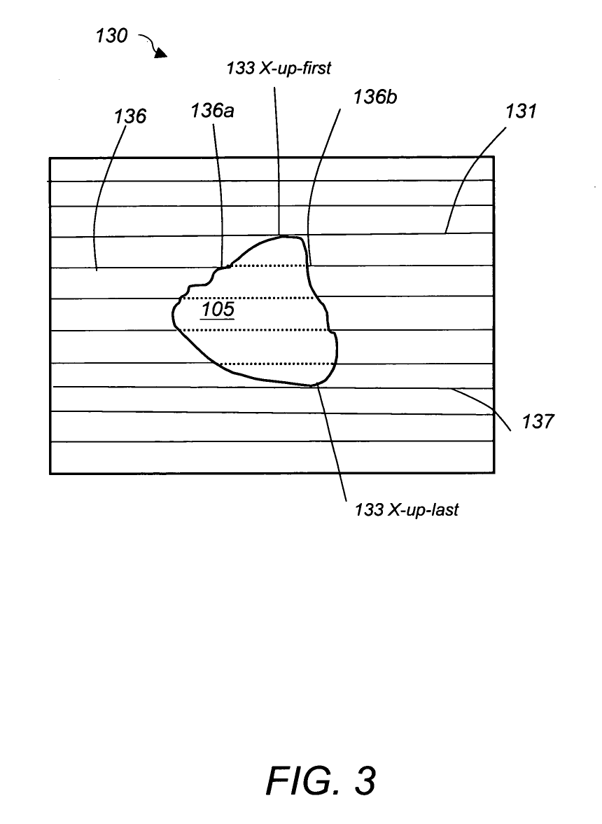

Referring to FIG. 3, the process of reducing a sequence of video frames 130 into useful object motion data includes the following steps. Each horizontal video scan line 131 is examined pixel-by-pixel. When the color signature of a pixel exceeds the set threshold level, the program starts collecting data from the object 105 video signal. First, the program records the height of the object 105 in the video field 130 (i.e., the vertical location 133 X-up first point). The horizontal starting location 133 X-up first point, i.e., the first horizontal pixel location that exceeds the threshold, is placed in an accumulator, called x_up. When next in the horizontal scan line 136 a pixel with a color signature that is below the set threshold is found, the horizontal pixel value is placed in an accumulator called x_down (i.e., points along the solid portion of line 136). As each successive scan line is examined, the horizontal pixel location of the rising edge 136a and falling edge 136b of the threshold detection is added to accumulators x_up and x_down, respectively. This continues until a scan line 137 is found that does not have pixels that exceed the threshold (i.e., 133 X-up last point), at which time the lower extent of the object height is recorded. The difference between the vertical components of point 133 X-up last and point 133 X-up first gives us the height of the object 105. The difference between the average rising edge points 136a and the average falling edge points 136b gives us the width of the object 105.

The location (x, y) of the object 105 is calculated from the accumulated x_up and x_down points according to the following steps. The accumulated x_up and x_down values are divided by the scan lines count to find the average leading edge 136a and the average falling edge 136b of the object. These average leading and falling edges are also averaged to find the center x-location of the object. The top and bottom height measurements 133 X-up first, 133 X-up last are averaged to find the center y-location. This averaging scheme process produces data that exceed the pixel resolution of the camera. The larger the object 105 the greater the averaging will be, thereby creating more accurate data especially in the horizontal dimension.

This method of collecting data from a video field 130 produces far more data than simply the (x, y) pixel position of one object 105. For each video field 130, the following data are available:
Average x-pixel position
Average y-pixel position
Object average height
Object average width
Number of objects in the video field

The number of objects in the video field is an ancillary piece of information that is generated by the search algorithm.

In order to generate a three-dimensional (3D) representation of the object's motion, the object location process must be performed on two video fields taken simultaneously from two cameras 102, 104 setup in a pre-determined configuration, as shown in FIG. 1. Cameras 102, 104 must produce images at the same rate. In one example, cameras 102, 104 are NTSC camera signals that produce frames at 30 Hz. From this signal, the system uses the interlaced fields that occur twice for each frame and therefore, the actual data rate is 60 Hz. Simultaneous fields from each camera 102, 104 are at most 1/60 second apart. In other examples, the system 100 may use the PAL video standard, which is used widely in Europe and other parts of the world. PAL has a frame rate of 25 Hz, so in this case the data rate from the interlaced fields is 50 Hz.

The next step in the flow of data is to turn the average x- and y-pixel location from the two simultaneous cameras into 3D data. This is accomplished by using triangulation. In the triangulation method the geometrical setup of the cameras 102, 104 is used to define a 3D coordinate system. In the setup of FIG. 1, cameras 102, 104 are arranged horizontally at a distance 111 and at the same height. In one example, distance 111 is approximately 2 meters and the experiment area 110 is about 1.4 meters away from the cameras 104, 102. They are arranged so that the optical axes 104a, 102a of the cameras 104, 102, are at a known angles 107a, 107b, and they are equidistant from the optical axes' intersection point 109. In the algorithm, the origin of the 3D x, y, z coordinate system is set at this intersection point 109, the x-axis runs parallel to a line 111 joining the two cameras, the y-axis runs perpendicular to this line 111 directly between the cameras, and the z-axis is vertical through the origin 109. The final piece of information needed is the horizontal (101a, 101b) and vertical (not shown) field-of-view angles subtended by the cameras 104, 102, respectively. These angles tend to be quite standard. Then, the x-pixel data from each camera is converted into a horizontal angular displacement from the centerline (or optical axis), and the y-pixel data from one camera is converted into a vertical angular displacement. By solving the horizontal and vertical triangles with these known angles, the object position can be calculated and converted to a point (x, y, z) through simple trigonometry. True units are calculated by scaling the results by the distance 111 that separates the cameras.

All measurement techniques of this type contain certain small and random errors. Therefore, a mathematical smoothing algorithm is used to improve the quality of the data. In the smoothing algorithm, an odd number of adjacent points (3, 5, 7, 9, etc.) are fitted to a parabola using a least-squares method. The middle point of the parabola is the new smoothed point. The data set of smoothed points is calculated by moving sequentially down the list of captured data points calculating each point using the desired odd number of points. The least-squares calculation requires the calculation and use of the first and second derivatives of the position data. Of course, the calculated first and second derivatives correspond to the velocity and acceleration of the moving object 105 and they are extracted and saved with the smoothed position data.

As the smoothing algorithm needs several data points, there is an issue about aligning data. This will be illustrated with an example. If the program is set to require 7-point smoothing, then during an experiment, the first smoothed point is not generated until seven points are taken. This smoothed point corresponds to the fourth point taken. Thereafter, the “current” smoothed point is 4 points before the most recently captured point (as we are smoothing the middle point of the seven). Given this situation, a trick was devised in order to align the smoothed data with the other variables: the captured time variable, un-smoothed data, and ancillary data (object height, width, etc.). This is accomplished by placing these data in short “waiting queues” that are (n/2)+1 the size of the smoothing interval. Then, when the smoothing algorithm has generated a point, all corresponding data is saved at the same time.

During the accumulation of the object data, many conditions are checked so that a legitimate object is found. These conditions are used for data filtering and are listed below.

Object Overlap

In the object search algorithm, after the first scan line has started to record an object, the rising and falling edges of successive lines must overlap with those of the previous line or otherwise the object is rejected.

Minimum Size

Target objects must be of sufficient size in order to be recognized as a found object.

Single pixel color matches regardless of intensity are rejected. The size of the minimum object is set by the user and is in the range between 2×2 pixels and 12×12 pixels. This becomes one more tool that the user has to improve the data quality.

Debounce

The method of identifying an object by the color in the video frame has many complications. Often the edges of an object appear fuzzy in the view of the video camera or specular reflections (or highlights) can cause a single object to appear like two or more. For example, when examining a particular video scan line, a threshold transition indicating an object may skip a short interval before a continuous high level of color is found. The falling edge of an object may also be fuzzy. This phenomenon is similar to the multiple transitions that can occur when the contacts of a mechanical switch bounce when it is thrown. We have adopted the same name for the algorithm solution of this problem effect, i.e., “debounce filtering”.

Horizontal “Debounce Filtering”

In examining the pixels in a scan line trace, when an upward threshold-crossing pixel is found, a pixel counter is started for a “debounce period” (adjustable) which prevents low-going transitions from being detected. Similarly, when a falling edge is found there is a debounce period during which pixels must be low before the falling edge will be logged into the x_down accumulator.

Vertical “Debounce Filtering”

Normally, when an object has been found and position data are “accumulated” scan line by scan line, the signal that the end of the object has been found is when a scan line with no transition that overlaps the previous line's transitions is found. To debounce a fuzzy transition in the vertical case this procedure is used: If the algorithm locates a second object in the video frame, it checks to see if the second object is separated from the first object by only a small break (i.e., a small number of scan lines) and if it overlaps the first object horizontally. If this is true, the two objects are joined into one. This procedure works well if the object is broken into multiple vertical objects.

Number of Objects

In general, the object search algorithm can keep track of up to three distinct objects in each video field. However, it passes only one on for calculation. Criteria such as largest object or highest object (as mentioned above) are used to decide which object to hand on and which to filter out.

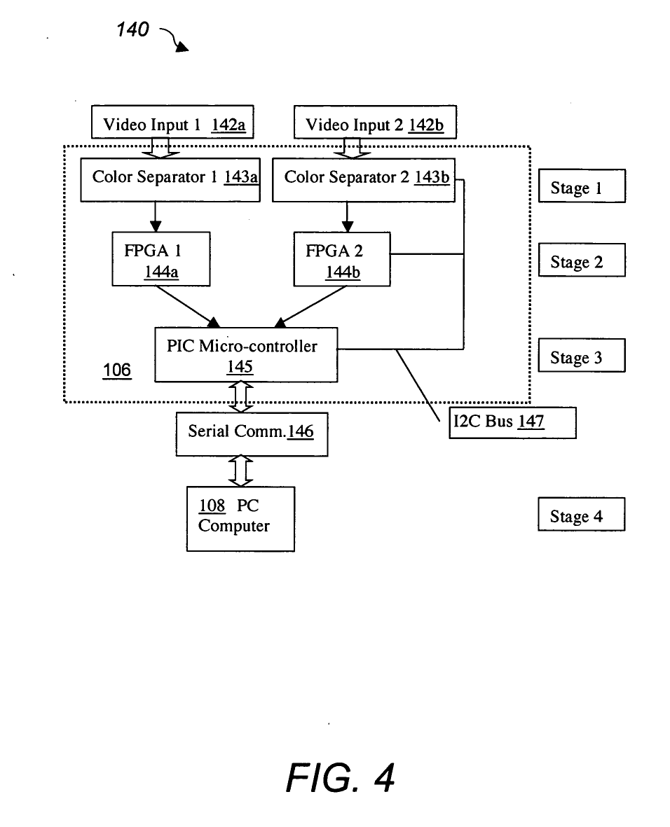

Referring to FIG. 4, the hardware architecture 140 of the motion visualizer system 100 includes two video inputs 142a, 142b that correspond to the two processing channels for the 2-camera, 3D system. Each video input 142a, 142, passes through a color separator 143a, 143b, and a Field Program Gate Array (FPGA) 144a, 144b. The two outputs of the FPGAs 144a, 144b, connect to the PIC Micro-controller 145 of the video controller 106. The PIC Micro-controller 145 connects to the PC computer 108 via a serial communication interface 146. The communication between the PC computer 108 and the Micro-controller 106 is bi-directional. A computer program in the PC computer 108 issues commands that configure and control the PIC micro-controller 146. The PIC micro-controller 146 is able to control both Field Program Gate Arrays (FPGA's) 144a, 144b and the color separators 143a, 143b, via an I2C Bus 147, thereby allowing the system to have different threshold values and colors.

The hardware system 140 of FIG. 4 is used to perform the following signal processing steps. In Stage 1 the digital color separators 143a, 143b receive the two video signals 142a, 142b, and produce a stream of numbers corresponding to the intensity of the selected color. In Stage 2, the FPGA chips 144a, 144b, search for intensity values that exceed the set threshold. They also perform the functions of data filtering and counting of horizontal pixels positions, as was described above. In Stage 3, the microcontroller 145 takes the threshold levels and horizontal counter values and vertical and horizontal sync signals and finds the objects in the field of view of each camera. Each data transmission contains the object information from the simultaneous frames of the two video cameras. Finally, in Stage 4, the PC computer 108 receives the string of data through the serial port 146. The computer 108, first parses the data to check that each data transmission is of the correct number of bytes and in the correct form. Then the computer 108 calculates and records the object data including average x-pixel position, average y-pixel position, object average height, object average width, and number of objects in the video field.

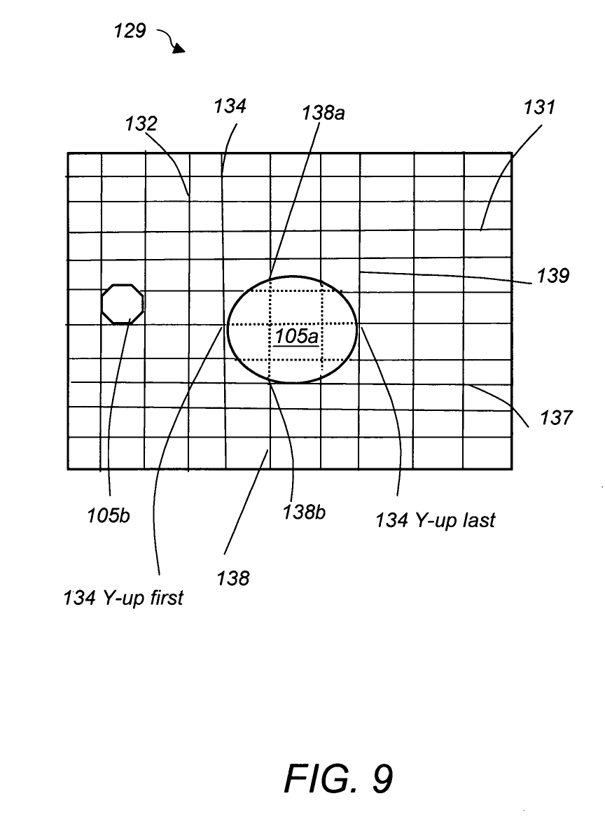

In another embodiment of the motion visualizer system, instead of the signal-processing system and method of FIG. 4, a software based method is used by the PC computer to process a direct digital video signal from the camera. The software based method of locating the object 105 via image processing is similar to the signal processing method of FIG. 4, with the exception of the following points:
The debounce is not implemented with a counter/timer, but rather spatially.
A maximum intensity level of a given color is calculated for a field, and used to automatically adjust the threshold level to adjust for changing lighting conditions.
The location averaging scheme described for the horizontal scan lines 131, 136, 137 (accumulating x_up and x_down for all horizontal scan lines that the object 105a is in) is also applied to the vertical scan lines 132, 134, 138 (shown in FIG. 9). Referring to FIG. 9, each vertical video scan line 132 is examined pixel-by-pixel. When the color signature of a pixel exceeds the set threshold level, the program starts collecting data from the object 105a video signal. The vertical starting location 134 Y-up first point, i.e., the first vertical pixel location that exceeds the threshold, is placed in an accumulator, called y_up. When next in the vertical scan line 138 a pixel with a color signature that is below the set threshold is found, the vertical pixel value is placed in an accumulator called y_down (i.e., points along the solid portion of line 138). As each successive vertical scan line is examined, the vertical pixel location of the rising edge 138a and falling edge 138b of the threshold detection is added to accumulators y_up and y_down, respectively. This continues until a vertical scan line 139 is found that does not have pixels that exceed the threshold (i.e., 134 Y-up last point), at which time the right extent of the object width is recorded. The difference between the x-locations of point 134 Y-up last and point 134 Y-up first gives us the width of the object 105a. In this video field 129 we observe the video signals from two objects 105a, 105b.
Rather than searching every row in order to find the start of an object, objects are searched for by taking the location of an object in a previous field, and searching outward from the previous position until a pixel is found that exceeds the current threshold. From there, adjacent pixels are tested (horizontally and vertically) to accumulate the rows and columns of an object. If there is no known previous position, every nth pixel is tested in every nth row to locate a pixel whose value exceeds the threshold. Once a start pixel is found, adjacent pixels are tested as described above.

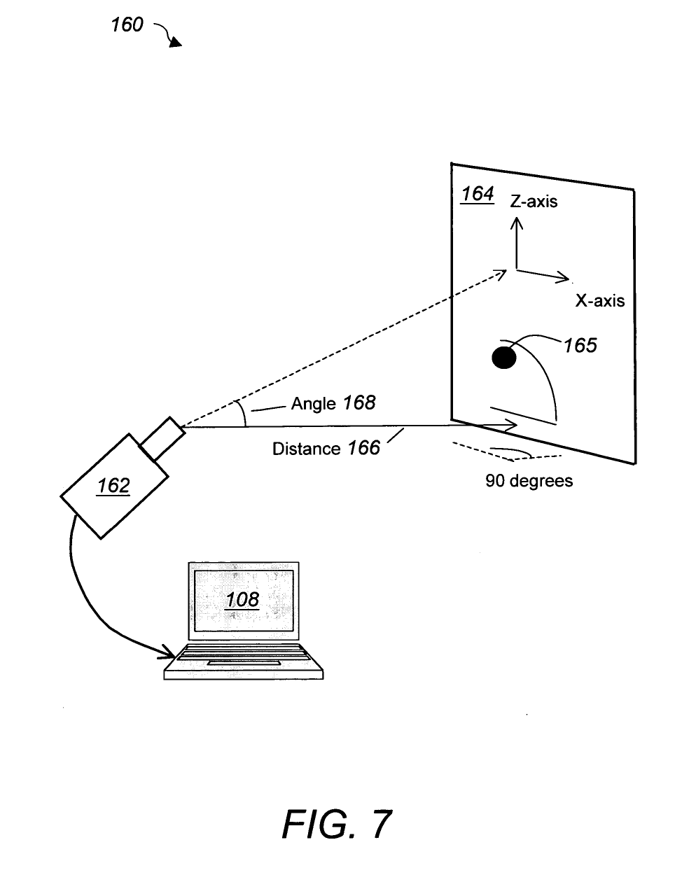

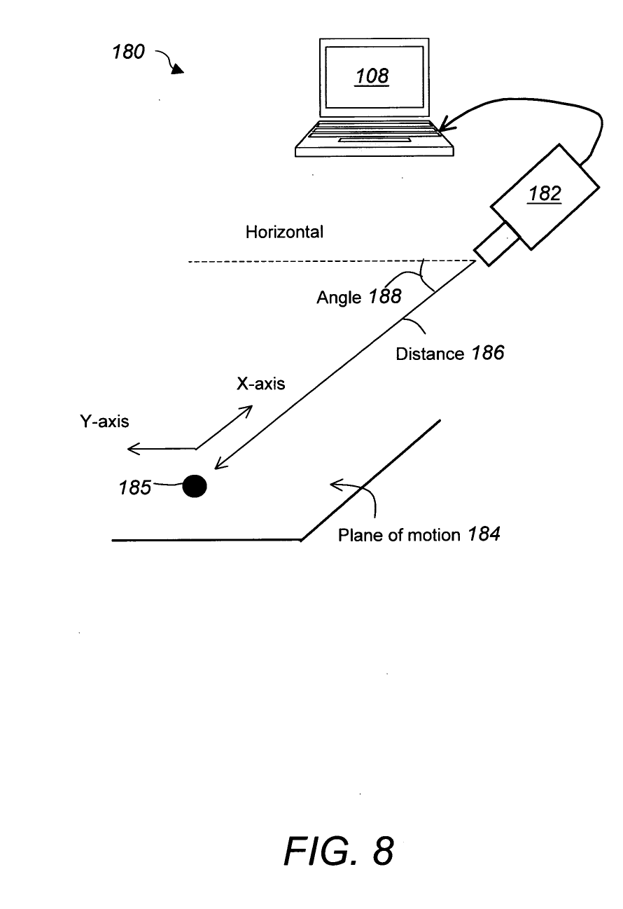

Embodiments of the motion visualize system that utilize the software-based method for locating an object are shown in FIG. 7 and in FIG. 8. In these embodiments, the motion visualizer 160 or 180 includes only one camera 162 or 182 and displays two-dimensional (2D) motion of the object 165 or 185, respectively. A PC computer 108 receives directly the digital video signal from the camera 162 or 182 and processes the video signal using the above mentioned software method. In the 2D motion visualizer setups, the camera 182 is placed above the motion plane 184 and angled towards the experiment area for recording the motion of the object 185 on the horizontal plane 184, as shown in FIG. 8. If the object motion is in a vertical plane 164, as shown in FIG. 7, the camera 162 is placed perpendicular to the plane of motion 164 in the horizontal plane. The camera 162 may be angled up or down in the vertical plane to best capture the motion of the object 165.

The motion visualizer system 100 of FIG. 1 may also be used with the software-based signal processing method by feeding directly a digital video signal from the cameras 104, 102 to the PC computer 108. The motion visualizer system 100 of FIG. 1 may also utilize only one camera to display two-dimensional (2D) of the object 105.

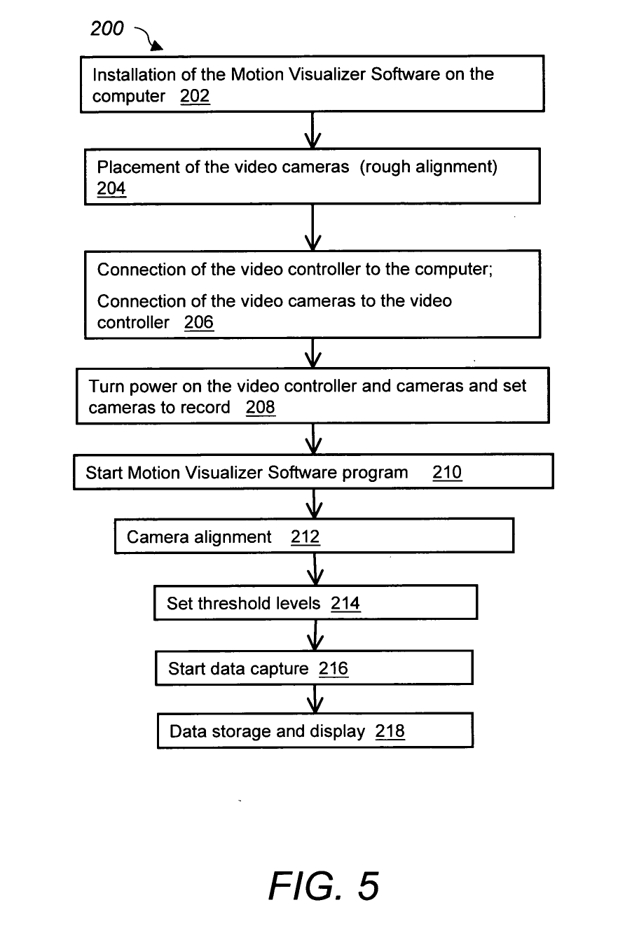

The process 200 of setting up and using the motion visualizer system is described with reference to FIG. 5. First, the user installs the motion visualizer software in the computer 108 (202). Next, the user mounts the video cameras 102, 104 in a level position on tripods or a table (204). The cameras 102, 104 are placed approximately 2 meters apart and about 1.4 meters from the experiment area 110. The user connects the video controller 106 to the COMI port of the computer 108 using a 9-pin RS-232 serial interface cable 103c and the output of the video cameras 102, 104 to the video controller 106 using video cables 103a, 103b, respectively (206). The video cameras are identified as left camera 102 and right camera 104 and are connected to the corresponding left and right video inputs of the video controller 106. Left and Right is determined by facing the experiment area 110 from behind the video cameras. Next, the user turns on the power to the video controller 106 and the cameras 102, 104 and sets the cameras to the widest field of view (208). If instead of video cameras, video camcorders are used the camcorders are set to record. It is important to look through the camera's viewfinder to make sure that no other brightly colored object exists in the background that has the same color as the experiment object 105. Next, the user starts the motion visualizer program (210) and proceeds with the alignment of the cameras (212).

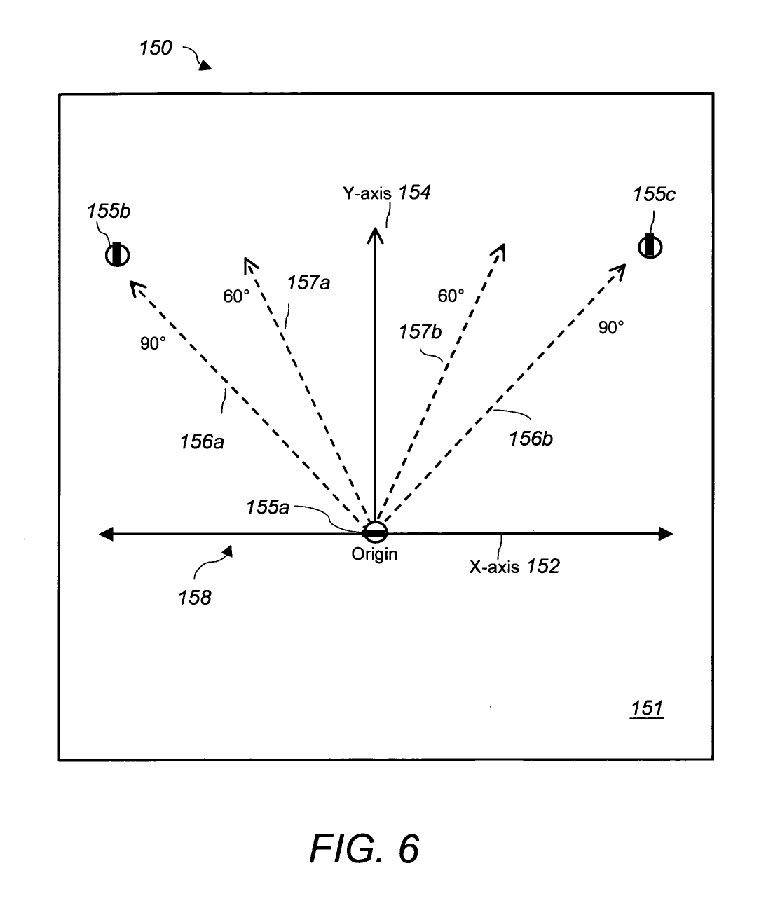

Referring to FIG. 6, the camera alignment process includes setting the angle, distance and orientation of the cameras and utilizes an alignment tool 150 that is provided with the equipment. The alignment tool 150 is a hard piece of plastic 151 that includes an X-Y coordinate system 158. The X-Y coordinate system 158 includes an X-axis 152, a Y-axis 154, additional alignment lines at various angles 156a, 156b, 157a, 157b, and holes at the origin 155a, and at the top of the 90° degree alignment lines 155b, 155c. The user places the alignment tool 150 in the center of the experiment area 110 and inserts an orange or green K'nex “flag” into the hole 155a in the origin of the X-Y coordinate system and in the holes 155b, 155c along each 90° degree alignment lines 156a, 156b, respectively. Next the user loops the provided 1.4 meter long cord around the origin flag 155a and the 90° degree alignment flag 155b, extends the cord fully along the 90° degree alignment line 156a and places the first camera tripod at the end of the cord. The same process is repeated for the other 90° degree alignment flag 155c and the second camera. The user then aims each camera to center the origin flag 155a in the camera's viewfinder horizontally. While keeping the camera horizontal the user raises or lowers the camera on the tripod so that the origin flag is seen in the bottom ⅓ of the camera's field of view. Next, the user enters in the camera alignment box of the program or accepts the default settings for the angle 107a, 107b between the cameras, the distance 111 and view. This completes the cameral alignment process and the user moves to the step of setting the threshold or video levels (214). Referring to FIG. 2 and FIG. 1, the user places the orange experiment object 105 in the center of the experiment area 110 and selects the camera to be adjusted, i.e., left or right. Then he clicks the start button 128 and uses the slider bar 125 to adjust the video threshold level. The user sets the level to the middle of the region where one horizontal bar 123 is seen in “scan line view” 121, corresponding to the experiment object 124 in “object view” 122. Optimal setting is 20-30 for normal, indoor lighting conditions. Then he clicks stop and repeats the process for the other camera and then saves the settings. Referring back to FIG. 5, after setting the threshold levels (214), the users clicks the start button on the motion visualizer toolbar to start capturing experimental data (216). Finally the data are stored and displayed in real time (218).

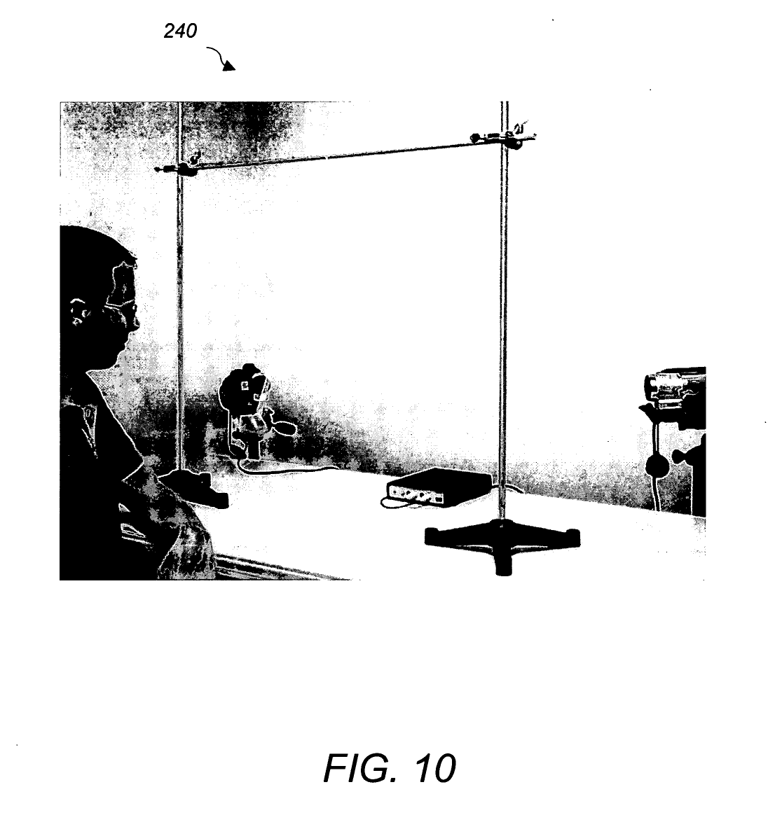

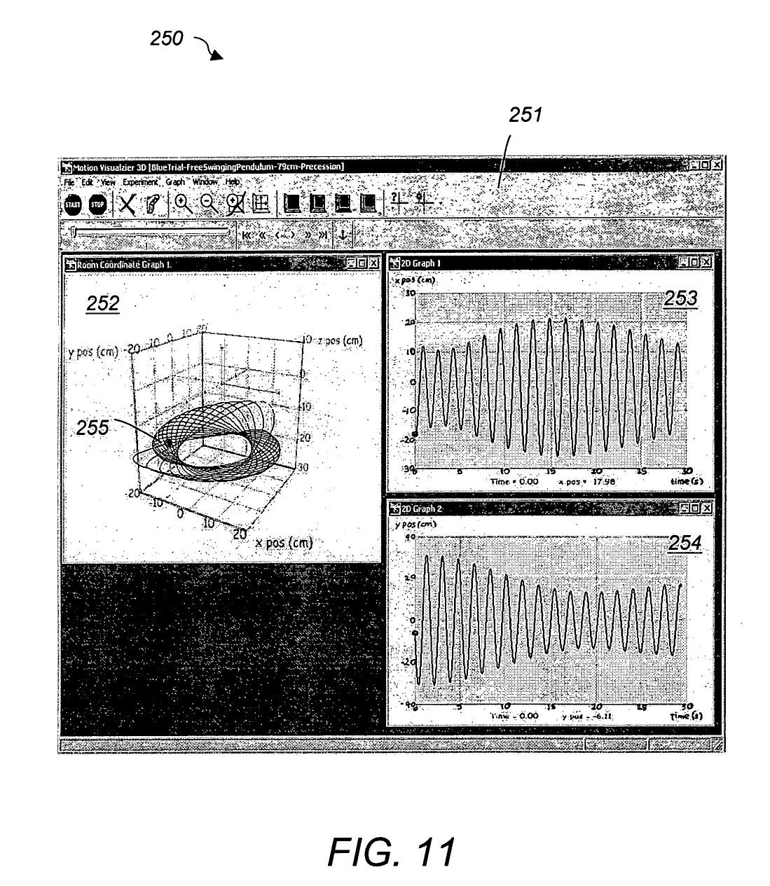

Referring to FIG. 11, the user interface 250 for the Motion Visualizer system is a Multiple Document Interface (MDI). In a MDI a single menu bar and button bar 251 at the top of the screen provides controls for multiple documents 252, 253, 254 contained in the main “client” window. In the Motion Visualizer system the main client window contains any combination and number of 2D (253, 254) and 3D (252) graphs. The top of the main window includes a simple menu bar 251 that controls standard file operations (File, Edit), setup of program appearance and functions (View), control of data acquisition (Experiment), and control and appearance of the graphs (Graph). The possibility of the capture of an object's motion in 3D space means that it can be represented in a 3D perspective or orthographic graphs. Each axis represents a dimension (x, y, and z) of position. This graph can be turned via arrow keys or by buttons or menu bar items to reveal how a motion looks from different viewpoints. It is safe to say that one of the innovations of the Motion Visualizer 3D is its ability to capture the 3D perspective view that really represents a “picture” of the motion. It is clearly the first such graph in an educational product, especially one that gathers these data in real-time and allows real-time modification of point-of-view. This picture-graph is very tightly representative of the motion that is occurring and hence is an easily understandable representation of the motion. One example of this capturing of a motion picture is shown in FIG. 10 where the motion of a pendulum is recorded and the 3D graph 252 and 2D graphs 253, 254 of the pendulum's motion are shown in FIG. 11. The graphs 252, 253 and 254 are displayed in real-time and simultaneously with the collection of the experiment data.

Two types of 3D graphs are defined in Motion Visualizer 3D. The default 3D graph is the graph type we call “Room Coordinate Graph” 252. This graph 252 always displays data in the default coordinate system that is defined by the camera setup that we call the “Room Coordinate System.” This is the system that has the origin (point 0, 0, 0) at the intersection of the optical axes of the two cameras, the x-axis parallel to the cameras, the y-axis running between the two cameras, and the z-axis vertical. This graph always has equivalent scales on all three axes, therefore motions are presented without distortions, and do represent a picture of the motion. A second type of 3D graph (called simply “3D Graph”) allows any variable (time, position, velocity, acceleration, etc.) to be plotted on any axis. Furthermore, the scales of the graph axes can be set to any value. This graph is really an extension of a 2D graph into the 3D dimension and is useful for examining more advanced kinematic relationships.

All graphs (2D, 3D, and Room Coordinate) are connected in time by the display of a “cursor” 255 that is attached to one data set at a time. During a running experiment, this cursor represents the most recently plotted point. It is the “live” point. All points in the past remain visible by leaving a trail of either a line or a set of points. (This is user selectable.) After an experiment concludes, the cursor returns to the beginning of the data set and may be moved by sliding the slider on the “timebar” or clicking on the timebar arrow keys. As the cursor is moved, the same point in time is indicated by the cursor on all open graphs showing the link between all graphs. Also, on each graph the values of the data at the cursor's position is displayed allowing for direct numerical comparison of the motions kinematics.

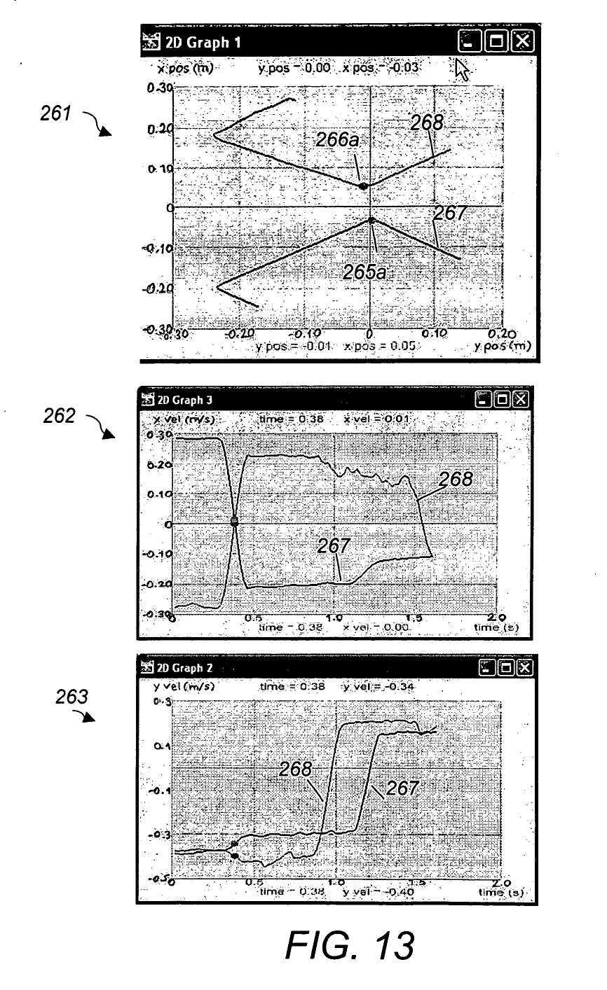

In physics and math education, 2D graphs that show change over time are important subjects for understanding. Motion Visualizer 3D provides a method for increasing students' ability to understand 2D graphs by forging this strong link with the 3D graph “picture.” This link is enhanced by the appearance on the screen of the cursor 255 that is a ball the color of the target object (that, in practice, is often a ball). The ball in the experiment is truly represented by the ball on the screen. The Motion Visualizer 3D allows up to four sets of data to be displayed. Each data set appears in a different color. This has allowed a method of automatically naming the data sets, for example, “BlueTrial,” or “GreenTrial”. Examples of 2D graphs include X or Y position versus time graphs 253, 254, respectively, shown in FIG. 11, velocity versus time graphs, 262, 263, and X versus Y graphs 261, shown in FIG. 13.

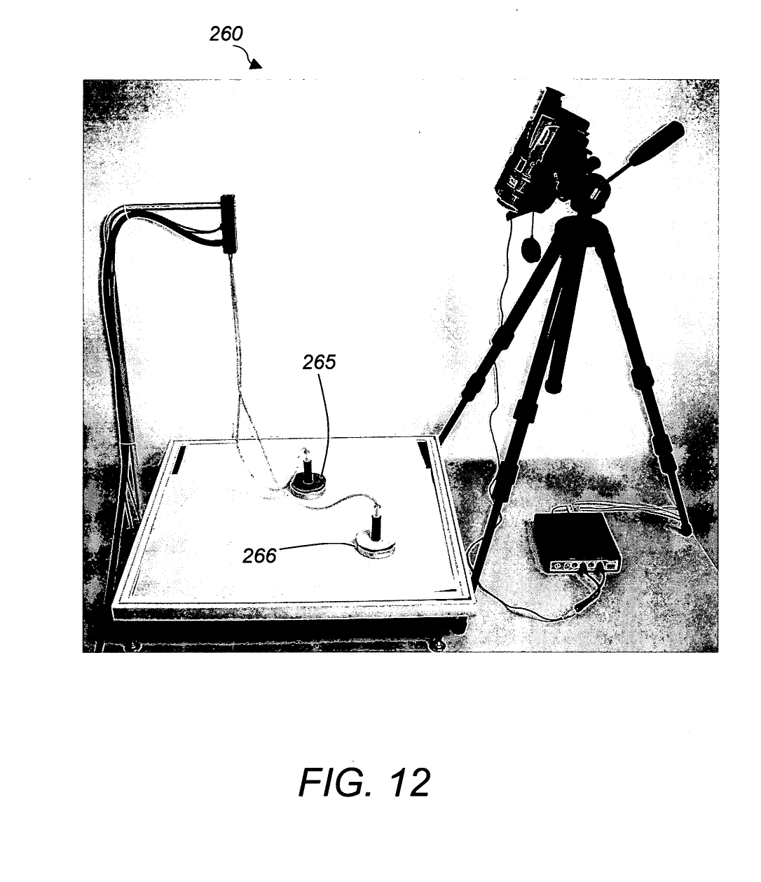

When the Motion Visualizer 3D system is used in the 2D mode with one-camera as shown in FIG. 12, two objects 265, 266 may be tracked at a time. There are two traces 267, 268 captured and shown in the display screen, shown in FIG. 13. The two traces 267,268 are also color coded to correspond to the color code of the objects 265, 266. There are also two cursors 265a, 266a representing the objects 265, 266, respectively, shown in FIG. 13, during (and after) two-object tracking. The cursors 265a, 266a, are set to the tracking colors, so for instance, one may be orange and the other yellow. Once again, this forges a strong link with the actual experiment.

Clearly, there is the possibility of a great deal of data on the screen at any one time, often too much to make sense out of. Motion Visualizer 3D allows two ways to limit the data on-screen without deleting any data. Both of these methods are accessed by the Show/Hide feature on the Experiment Menu and button bar. First, using the Show/Hide menu, a data set can be turned on or off by selecting “Show All” or “Hide All” for a particular data set. Second, a particular chunk of data within a data set can be displayed while the rest is hidden. This is accomplished by use the “anchor” on the timebar. The time cursor is moved to one end of the segment to be displayed, then the anchor button is pressed, then the cursor is moved to the other end of the segment to be displayed, and the anchor button toggled off. With a segment of data selected, the Show/Hide menu shows an option of “Show Selected” that when selected will hide all other data for that data set.

It has been confirmed by research since approximately the mid-80's that computer systems equipped with probes that take real-world measurements and present those measurements in real-time have special value as educational tools. One reason for this is that the causal link between an event and its abstract representation is made transparent to learners. Furthermore, there is also a kinesthetic dimension to the learning. As students need to use their hands and bodies actively while making measurements, they internalize the meaning of the graphs better. Finally, these tools for learning are, in fact, true scientific tools that allow students to learn science by doing science, and therefore serve the central tenant of the national science education reform of the 1990's, learning through inquiry. For these reasons, a whole class of educational tools build around the real-time presentation of data has arisen. These tools were originally known as microcomputer-based labs (MBL), but are more recently known as probeware or simply by the more industrial name, data acquisition.

One application of the Motion Visualizer system is for MBL-based teaching of motion in physics and mathematics course using the real-time video analysis. Clearly our approach of real-time motion detection overcomes many of the problems of frame-by-frame mouse clicking. It places video motion analysis in the well-established genre of MBL with its strong causal links between events and representations and the benefits of kinesthetic learning. MBL has a much more fully developed research base than frame-by-frame video analysis and has been shown to be helpful for younger students (middle school and early high school) as well as upper-level high school and college students.

The use of the Motion Visualizer system for MBL-based teaching of motion provides the following possibilities.
Developing spatial visualization skills representing 3D motions on a 2D screen.
Bringing the study of physics into students' own world.
Making motion studies more engaging by enabling studying of motions that were not possible before.
Tool for teaching the vector nature of motion
Tool for measuring the complete energy of a system

This technology has allowed us to research a new field to standard-practice education, that of students investigating how 3D motions are represented in two-dimensions. For the first time there is available to education a tool for students to explore their understanding of how shapes and motions look from different points of view. The ability to visualize shapes in space has been shown to be a predictor of those who pursue careers in science and mathematics and for academic success in general. Certain students seem to have a proclivity for it while others do not. Despite the importance of this skill it is largely ignored throughout most students' schooling. Now, the Motion Visualizer 3D lets students practice and test their abilities. Two activities that we have incorporated into our activity book packaged with the Motion Visualizer 3D illustrate how students can engage in developing spatial visualization skills using Motion Visualizer 3D. One is by asking students to imagine a motion that they know they can reliably make such as a particular hand motion or a motion using some simple equipment such as a string, a ball, or a tin can. Then they are asked to draw a sketch of the motion (a prediction) as it would look from three points-of-view: the front, side, and top. They then perform the motion as it is captured by the Motion Visualizer 3D and compare their predictions to the results and reflect on discrepancies. Another activity is designed to draw connections between the kinesthetic feeling of drawing a particular shape in space and seeing its representation. Students are asked to draw a well-know 3D shape such as a cube or a pyramid in space using a red-colored “wand” that can be tracked by the Motion Visualizer 3D. Usually students use the visual feedback of the 2D representation of the shape and find it very difficult to decipher and use as feedback. It is often easier to do with the eyes closed. This highlights issues of translating 3D into 2D, particularly that a single view of a 3D motion does not fully describe that motion. The quality of depth cannot be fully perceived. It must be rotated to be understood.

One problem with the study of physics is that laboratory exercises seem remote from students' lives. Motion studies conducted on an air track or air table may teach students physical laws that they use in the context of school. However, students may not be able to relate these laws to the “real” world in which they live. They view the laboratory as a separate reality. They may pass the test based on these laboratory experiences but fail to see how the laws relate to their world and lives. The use of video cameras and 3D motion detection lets students investigate motions in their own world. They do that because they capture motions over a wide scale and they can capture whole motions. Video cameras are flexible tools that can capture motions large and small. Therefore, they can be used to study the centimeter-scale motions of a wind-up toy or the motions of a soccer kick or basketball free throw with the scale of approximately 10 m. Using the 3D capabilities of Motion Visualizer 3D, students can see the whole motion and extract from it the point of their interest. Even when learning the basics of one-dimensional motion representation, the Room Coordinate view can show the actual motion. For instance, if a student it tracking his or her own body motion and is walking forward and backward on the x-axis and graphing that x-position over time, side-to-side motions (in y), have no effect on the x-position vs. time graphs, but can be seen on the room coordinate graph. The reality is preserved, but the mathematical abstraction is made clear.

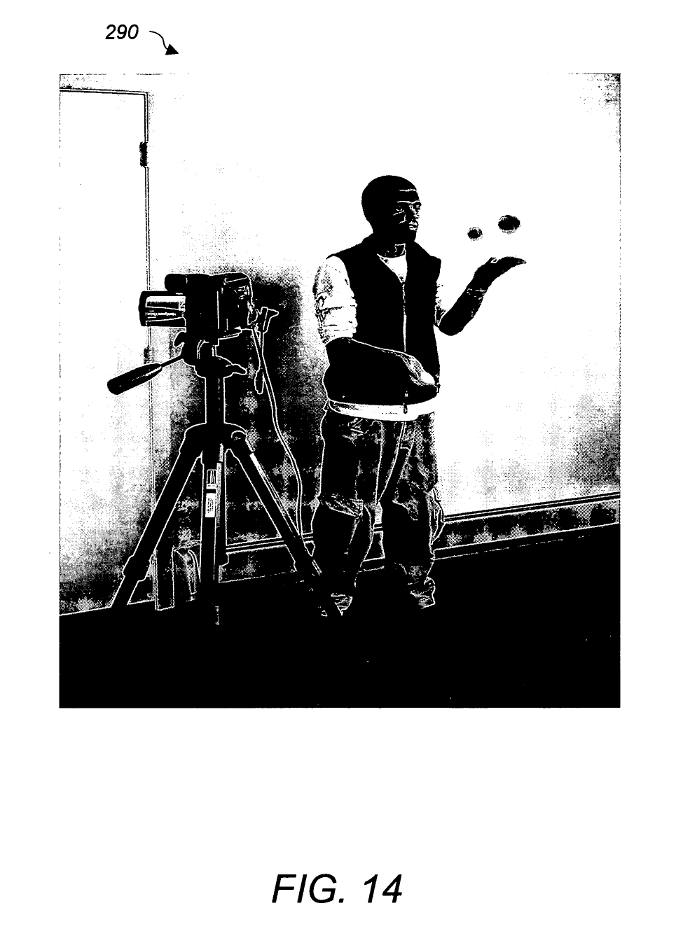

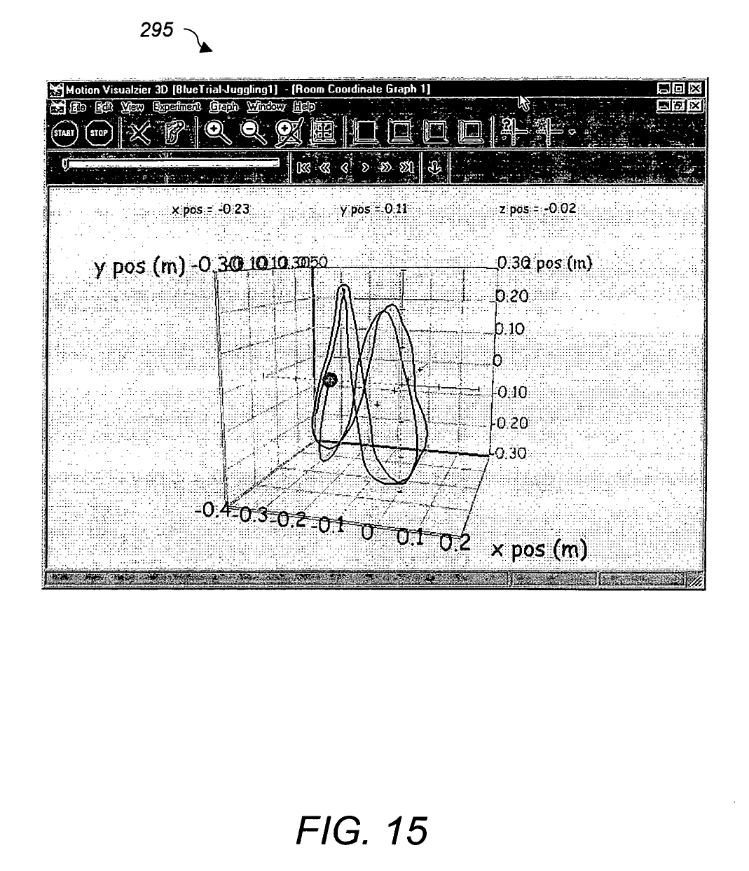

Coupled with the idea of bringing motion studies into students' world is the idea of just making motion studies more engaging, interesting, and fun. If students can study the motions that interest them, then they will be more invested in their work, and will learn more. One of our field-test classrooms illustrates this point. The teacher has designed a curriculum where a long-term project is used to frame and apply the basic mechanics materials that students work on most of the year. Students need to pick a motion that they are interested in and study first its kinematics and then fully develop its dynamics. Students have different measurement tools available to them. The introduction of Motion Visualizer 3D has widened the scope of motions that may be studied. With our program students have investigated motions of their choosing including yo-yos, soccer kicks, basketball free throws, playground swings, baseball pitching, acrobatics, juggling, and ten pin bowling ball pitches. Referring to FIG. 14, a student performing a juggling activity 290 is recorded by a camera of the Motion Visualizer system while simultaneously the computer displays the corresponding X-Y-Z coordinate 3D graph 295, shown in FIG. 15.

Motion detectors for education before the Motion Visualizer 3D have been (as noted above) almost exclusively one-dimensional. Ultrasonic rangers measure distance between the detector and the first object in front of it that produces an echo. Generally this distance is represented as positive displacement. Using these detectors students have little sense of a coordinate system defined in space, rather they are analogous to an automated tape measure producing isolated numeric measurements between two objects, the detector and the reflector. These measurements are always positive numbers (although some ultrasonic ranger software does allow an offset to be subtracted from measurement making the zero point arbitrary). In any event, these devices are rarely used to promote the idea that a coordinate system (even a one-dimensional one), is defined in space. Motion can be described mathematically using vectors. Moving from one-dimensional motion sensing to two-dimensions is a huge leap in generalizing the study of motion because the vector nature of the motion can be made apparent. Position must be represented by two numbers that relate to an “origin” defined by a coordinate system. This is a powerful mathematical idea with which students should have a great deal of experience. Here, motion may be broken into “components” that can be analyzed independently or looked at as vectors that have information from all components in them. When the vectors are looked at from specific points of view (using our 3D displays) the “components” are seen, then as the graphs are rotated the relationships between the components and the vectors or full 3D appearances are seen. For example, consider the motion of a compound pendulum (which has different periods in X and Y) swinging in the X-Y plane: when looked at from the “top view” a Lissajous pattern will be observed, when turned to the “side view” the Y periodicity will be seen, and when looked at from the “front view” the X periodicity will be seen.

Several embodiments of the present invention have been described. Nevertheless, it will be understood that various modifications may be made without departing from the spirit and scope of the invention. Accordingly, other embodiments are within the scope of the following claims.

1. A system for capturing and displaying motion of an object comprising:
a first equipment for capturing a first set of visual images of said object's motion over time;
a computing device for receiving a signal of said first set of visual images of said object's motion and converting said signal of said first set of visual images into a graphical representation of said object's motion and displaying said graphical representation of said object's motion on a display screen in real time with said capturing of said first set of visual images.

2. The system of claim 1 wherein said graphical representation of said object's motion comprises a position coordinate graph.

3. The system of claim 1 wherein said graphical representation of said object's motion comprises a position versus said time graph.

4. The system of claim 2 further comprising a second equipment for capturing a second set of visual images of said object's motion over said time and wherein said computing device receives a signal of said second set of visual images and combines said second set visual image signal with said first set visual image signal and converts said combined first set and second set visual image signals into a graphical representation of said object's motion and displays said graphical representation on said display screen in real time with said capturing of said first set and second set of visual images.

5. The system of claim 4 wherein said graphical representation comprises a three-dimensional position coordinate graph.

6. The system of claim 5 wherein said computing device converts said combined first set and second set visual image signals into a graphical representation of said object's motion via triangulation.

7. The system of claim 6 wherein said first and said second equipment comprise a first and a second optical axis, respectively, and are arranged so that their corresponding first and second optical axes are at a known angle and said first and said second equipment are equidistant from said first and said second optical axes' intersection point.

8. The system of claim 7 wherein said three dimensional position coordinate graph comprises said object's position coordinates plotted in a three dimensional x-y-z Cartesian coordinate system and wherein said x-y-z Cartesian coordinate system comprises an origin located at said intersection point of said first and said second optical axes, an x-axis running parallel to a line joining said first and said second equipment, a y-axis running perpendicular to said line joining said first and said second equipment directly between said first and said second capturing equipment and a z-axis running vertical through said origin.

9. The system of claim 8 wherein the length of said line joining said first and said second equipment is used to scale and calculate said position coordinates in true distance units.

10. The system of claim 1 further comprising a video controller for receiving an analog signal of said first set of visual images, locating said object and transmitting a signal of said object's location to said computing device.

11. The system of claim 10 wherein said object comprises a bright color and said video controller locates said object in said first set of visual images based on said bright color exceeding a set threshold level of brightness.

12. The system of claim 10 wherein said signal of said object's location comprises average x-pixel position, average y-pixel position, object average height, and object average width.

13. The system of claim 1 wherein said signal comprises a digital video signal and said computing device further comprises an object locating algorithm for receiving said digital video signal and locating said object.

14. The system of claim 13 wherein said object comprises a bright color and said object locating algorithm locates said object's position coordinate data in said first set of visual images based on said bright color exceeding a set threshold level of brightness.

15. The system of claim 14 wherein said object's position coordinate data comprise average x-pixel position, average y-pixel position, object average height, and object average width

16. The system of claim 1 wherein said first set of visual images comprise motions of more than one objects.

17. The system of claim 1 wherein said first set of visual images are captured at a frequency of 30 times per second.

18. The system of claim 4 wherein said first set and said second set of visual images are captured at a frequency of 30 times per second each and said computing device receives interlaced images of said first set and said second set of visual images at a frequency of 60 times per second.

19. The system of claim 1 wherein said first capturing equipment is selected from a group consisting of a video camera, a video recorder, a NTSC camcorder, and a PAL camcorder.

20. The system of claim 1 wherein said graphical representation of said object's motion comprises a velocity versus time graph.

21. The system of claim 1 wherein said graphical representation of said object's motion comprises an acceleration versus time graph.

22. The system of claim 8 wherein said object's position coordinate data are smoothed to correct for small and random errors via an algorithm that fits a parabola to an odd number of adjacent position coordinate data using a least-squares method.

23. The system of claim 8 wherein said object's position coordinate data are filtered using filters selected from a group consisting of a minimum object size filter, a debounce horizontal filter, a debounce vertical filter, and an object overlap filter.

24. The system of claim 1 wherein said computing device is selected from a group consisting of a personal computer, a notebook computer, a server, a computing circuit, and a personal digital assistant (PDA).

25. A method for capturing and displaying motion of an object comprising:
providing a first equipment for capturing a first set of visual images of said object's motion over time;
providing a computing device for receiving a signal of said first set of visual images of said object's motion and converting said signal of said first set of visual images into a graphical representation of said object's motion and displaying said graphical representation of said object's motion on a display screen in real time with said capturing of said first set of visual images.

26. The method of claim 25 wherein said graphical representation of said object's motion comprises a position coordinate graph.

27. The method of claim 25 wherein said graphical representation of said object's motion comprises a position versus said time graph.

28. The method of claim 26 further comprising providing a second equipment for capturing a second set of visual images of said object's motion over said time and wherein said computing device receives a signal of said second set of visual images and combines said second set visual image signal with said first set visual image signal and converts said combined first set and second set visual image signals into a graphical representation of said object's motion and displays said graphical representation on said display screen in real time with said capturing of said first set and second set of visual images.

29. The method of claim 28 wherein said graphical representation comprises a three-dimensional position coordinate graph.

30. The method of claim 29 wherein said computing device converts said combined first set and second set visual image signals into a graphical representation of said object's motion via triangulation.

31. The method of claim 30 wherein said first and said second equipment comprise a first and a second optical axis, respectively, and are arranged so that their corresponding first and second optical axes are at a known angle and said first and said second equipment are equidistant from said first and said second optical axes' intersection point.

32. The method of claim 31 wherein said three dimensional position coordinate graph comprises said object's position coordinates plotted in a three dimensional x-y-z Cartesian coordinate system and wherein said x-y-z Cartesian coordinate system comprises an origin located at said intersection point of said first and said second optical axes, an x-axis running parallel to a line joining said first and said second equipment, a y-axis running perpendicular to said line joining said first and said second equipment directly between said first and said second capturing equipment and a z-axis running vertical through said origin.

33. The method of claim 32 wherein the length of said line joining said first and said second equipment is used to scale and calculate said position coordinates in true distance units.

34. The method of claim 25 further comprising providing a video controller for receiving an analog signal of said first set of visual images, locating said object and transmitting a signal of said object's location to said computing device.

35. The method of claim 34 wherein said object comprises a bright color and said video controller locates said object in said first set of visual images based on said bright color exceeding a set threshold level of brightness.

36. The method of claim 34 wherein said signal of said object's location comprises average x-pixel position, average y-pixel position, object average height, and object average width.

37. The method of claim 25 wherein said signal comprises a digital video signal and said computing device further comprises an object locating algorithm for receiving said digital video signal and locating said object.

38. The method of claim 37 wherein said object comprises a bright color and said object locating algorithm locates said object's position coordinate data in said first set of visual images based on said bright color exceeding a set threshold level of brightness.

39. The method of claim 38 wherein said object's position coordinate data comprise average x-pixel position, average y-pixel position, object average height, and object average width

40. The method of claim 25 wherein said first set of visual images comprise motions of more than one objects.

41. The method of claim 25 wherein said first set of visual images are captured at a frequency of 30 times per second.

42. The method of claim 29 wherein said first set and said second set of visual images are captured at a frequency of 30 times per second each and said computing device receives interlaced images of said first set and said second set of visual images at a frequency of 60 times per second.

43. The method of claim 25 wherein said first capturing equipment is selected from a group consisting of a video camera, a video recorder, a NTSC camcorder, and a PAL camcorder.

44. The method of claim 25 wherein said graphical representation of said object's motion comprises a velocity versus time graph.

45. The method of claim 25 wherein said graphical representation of said object's motion comprises an acceleration versus time graph.

46. The method of claim 32 wherein said object's position coordinate data are smoothed to correct for small and random errors via an algorithm that fits a parabola to an odd number of adjacent position coordinate data using a least-squares method.

47. The method of claim 32 wherein said object's position coordinate data are filtered using filters selected from a group consisting of a minimum object size filter, a debounce horizontal filter, a debounce vertical filter, and an object overlap filter.

48. The method of claim 25 wherein said computing device is selected from a group consisting of a personal computer, a notebook computer, a server, a computing circuit, and a personal digital assistant (PDA).

49. A method of using real-time video analysis of an object's motion for teaching kinematic processes in physics and mathematics courses comprising:
providing a system for capturing and displaying motion of an object said system comprising a first equipment for capturing a first set of visual images of said object's motion over time and a computing device for receiving a signal of said first set of visual images of said object's motion and converting said signal of said first set of visual images into a graphical representation of said object's motion and displaying said graphical representation of said object's motion on a display screen in real time with said capturing of said first set of visual images;
asking a student to imagine and draw a three dimensional representation of a first object's motion;
performing said first object's motion and capturing said first object's motion with said system for capturing and displaying motion of an object;
comparing said student's drawing of said three-dimensional representation of said first object's motion with said display of said first object's motion by said system.
